(19) United States
(12) Patent Application Publication
(10) Pub. No.: US 2009/0150222 A1
(43) Pub. Date: Jun. 11, 2009

(54) METHOD FOR INCREASING THE ACCURACY OF SOCIAL NETWORK PROFILES

(75) Inventor: Alexander Polonsky, Beit El (IL)

Correspondence Address: Alexander Polonsky, Dereh Hahaluzim ST. 21, Beit El, 90631, omitted

(73) Assignee: Alexander Polonsky, Beit El (IL)

(21) Appl. No.: 12/330,173

(22) Filed: Dec. 8, 2008

Related U.S. Application Data
(60) Provisional application No. 61/012,471, filed on Dec. 10, 2007.

(51) Int. Cl. G06Q 30/00; G06Q 99/00

(52) U.S. Cl. 705/10; 705/1; 705/14

(57) ABSTRACT

Described is a method for increasing the accuracy a profile of attributes, interests and preferences pertaining to individuals registered with virtual social networking services and a method of doing business wherein virtual advertising purchasers are offered increased precision in targeting commercial audiences, provided by the proprietor of a virtual social networking service. Registered users provide information regarding other users of the social networking services and are rewarded according to the success of adverts targeted to users according to the information they provided.

### RELATED APPLICATIONS

The present non-provisional application claims priority to provisional application No. 61/012,471, entitled “A method for increasing the accuracy of social network profiles”, filed Dec. 10, 2007.

### FIELD OF THE INVENTION

The present invention generally pertains to social network profiles, and more specifically to accurately segmenting profiles and matching them with relevant adverts.

### BACKGROUND OF THE INVENTION

As disclosed in U.S. Pat. No. 6,519,629, social networking websites such as Friendster, Facebook and MySpace offer registered users the opportunity to either interact with a predetermined list of friends, or seek out interaction with likeminded others. During the registration process those who wish to participate in the social network are queried as to their personal attributes, preferences and interests. At the discretion of the registered user these details, as well as other information the user makes available to the proprietor of the web based service, is viewable to other privy registered users.

In an effort to commercialize the social services provided by social networks, the details provided by registered users are processed, and corresponding commercial adverts and offers are directed at them and relayed to their interconnected social rings. This commercial targeting that relies on self professed interests and social circles is conventionally further enhanced by monitoring internet surfing habits and web based purchasing.

The accuracy of the details willingly provided by registered users can be verified to a certain degree against personal web browsing activity. For example: 1) the texts viewed by the users can be analyzed for key words and phrases; 2) the forums frequented by the users can be recorded; 3) Various methods may be used to analyze the users' social connections so as to extract information regarding the users.

However, many gaps still remain in the composition of a user's commercial profile. There is therefore a well felt need to add precision to the profile, thereby increasing the effectiveness of commercial adverts to which users and their circles of friends are exposed in the course of their web activity.

### SUMMARY OF THE INVENTION

It is an object of the present invention to disclose a method for increasing the accuracy of a profile of attributes, interests and preferences pertaining to individuals registered with virtual social networking services, wherein, in addition to self-regarding attributes, interests and preferences as divulged by the user during the registration process and web activity, registered users are encouraged to provide other-regarding attributes, interests and preferences pertaining to other registered users they claim familiarity with.

It is yet another object of the present invention to disclose a method of doing business wherein virtual advertising purchasers are offered increased precision in targeting commercial audiences, provided by the proprietor of a virtual social networking service by means of the processing and cross referencing of self-regarding and other-regarding information pertaining to the attributes, interest and preferences of registered users with a virtual formation gathered by the proprietor of a virtual social network.

It is within the scope of the present invention that the method for increasing the accuracy of a profile additionally comprises a step of verifying said claim of familiarity.

It is within the scope of the present invention that the method for increasing the accuracy of a profile additionally comprises a step of rating the credibility of information provided by users.

It is within the scope of the present invention that the method for increasing the accuracy of a profile additionally comprises a step of cross-referencing and statistically matching other-regarding and self-regarding information.

It is within the scope of the present invention that the method for increasing the accuracy of a profile additionally comprises a step of encouraging the disclosure said other-regarding information by means of incentives, including: cash payment, micro-payments, virtual currency, virtual services, credit towards purchase of products, rebates, and virtual accreditation.

It is within the scope of the present invention that the users are awarded incentives on the basis of actual clicks on adverts that were targeted at other users as a result of the information they provided.

It is within the scope of the present invention that the incentives are limited to adverts displayed on the web page of the user that divulged said other-regarding information.

It is within the scope of the present invention that the other-regarding information provided by individuals registered with a social networking service is rewarded by means of incentives, including: cash payment, micro-payments, virtual currency, virtual services, credit towards purchase of products, and virtual accreditation.

It is within the scope of the present invention that the incentives are financed directly by the advert purchasers.

It is within the scope of the present invention that the method of doing business wherein virtual advertising purchasers are offered increased precision in targeting commercial audiences, additionally comprises a step of gathering processing and selling the demographics of the users within said virtual social network that have been reported to show interest in the products advertised by said purchasers of adverts.

It is within the scope of the present invention that the method for increasing the accuracy of a profile comprises a step of notifying registered users, who have indicated interest in making new romantic or social contacts, of the contact details of others who share their interests and activities.

### BRIEF DESCRIPTION OF THE FIGURES

In order to better understand the invention and its implementation in practice, a plurality of embodiments will now be described, by way of non-limiting example only, with reference to the accompanying drawings, in which

FIG. 1 schematically illustrates shared attributes interests and preferences as extrapolated from personal self-regarding details as disclosed by the registered users in a web based social network.

FIG. 2 schematically illustrates shared attributes, interests and preferences as extrapolated from other-regarding data as provided by associates and friends of the registered users to which the data pertains.

FIG. 3 schematically illustrates shared attributes, interests and preferences regarding registered users identified as belonging both to self-regarding details as disclosed by the registered users and extrapolated from other-regarding data as provided by associates and friends of the registered users to which the data pertains.

FIG. 4 schematically illustrates a process by which a registered user provides other-regarding information regarding other registered users, and another registered user about which the above information has been provided is targeted by an advert, upon which the other registered user clicks, at which point the first registered user is rewarded.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a method for increasing the accuracy of social networking profiles. The method of the present invention has many technological advantages, among them:

Increased precession in social network profiling;

Cost effective exposure of individuals to revenue generating links during their web activity;
Effective niche marketing and sales;
Reduced deception and fraud;
Additional features and advantages of the invention will become apparent from the following drawings and description.

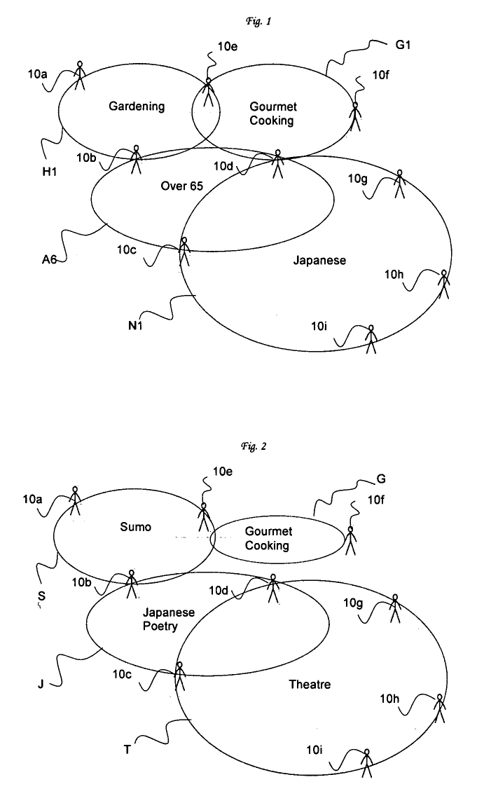

Reference is made now to FIG. 1 schematically illustrating a plurality of individuals 10a through 10i, representing a segment of the total registered with virtual social network 10 (not shown), having provided self-regarding information pertaining to gender, nationality, age and hobbies: individuals 10b 10c and 10d are identified as sharing age group A1; individuals 10e 10f 10d are identified as sharing gender G1; and individuals 10a 10b 10e are identified as sharing hobby Hi; 10c 10d 10g 10h and 10i are identified as sharing nationality N1.

Reference is made now to FIG. 2 schematically illustrating a plurality of individuals 10a through 10i, representing a segment of the total registered with virtual social network 10 (not shown), having provided other-regarding information pertaining to interests and hobbies: individuals 10b 10c and 10d are identified as sharing an interest in Japanese poetry J; individuals 10e 10f 10d are identified as sharing an interest in gourmet cooking G; individuals 10a 10b 10e are identified as sharing an interest in Sumo wrestling S; and individuals 10c 10d 10g 10h and 10i are identified as sharing an interest in theatre T.

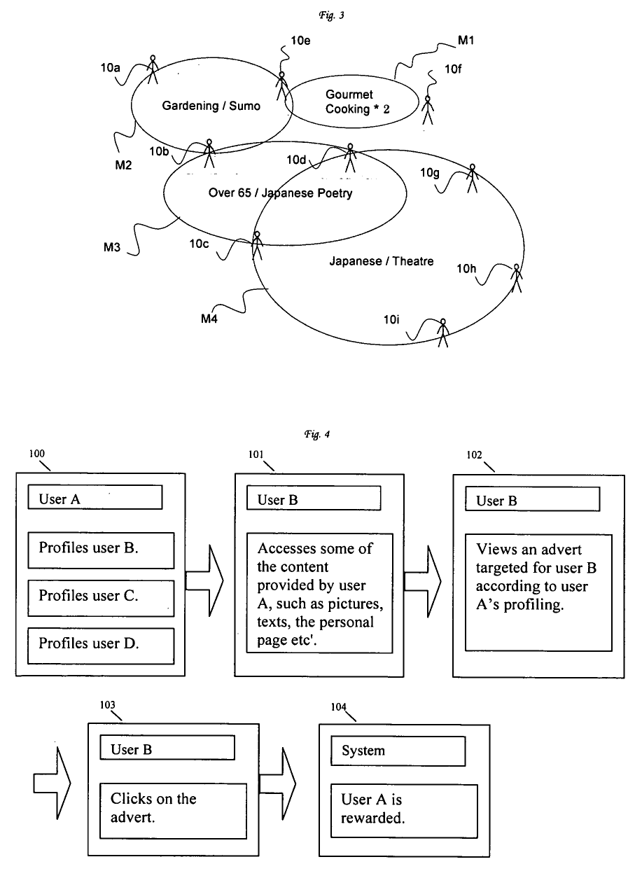

Reference is made now to FIG. 3 schematically illustrating a plurality of individuals 10a through 10i, representing a segment of the total registered with virtual social network 10 (not shown), where individuals 10e, 10f are identified as having a correlation between their self-regarding information (Gourmet Cooking) tally with the other-regarding information about them, while individuals 10a-f, 10g-h are identified as having differences between the self regarding and other-regarding information regarding them. It can now be determined what information is more reliable if necessary, or both can be regarded as reliable. In one embodiment this can be according to the number of registered users who provided other-regarding information that contradicts the self regarding information provided by a registered user.

Reference is made now to FIG. 4, schematically representing one the process inherent in one embodiment of the invention. Users A, B, C, D are users of the social network. User A provides other-regarding information regarding users B, C, D. This process is called “profiling” in the figure. User B accesses content provided by user A. While accessing the content, user B is shown an advert according to the information provided by user A. User B clicks on the advert, and user A is then rewarded for having provided information that led to user B's clicking on an advert.

In one embodiment self-regarding and other-regarding information can be cross-referenced with information gathered with external tools, including but not limited to analysis of text the user viewed while using the social network or while writing in the network, or by analyzing the user social network connection and building a user-profile according to information regarding the individuals identified as being the user's friend.

The other-regarding information provided by the user may be provided in various ways: various embodiments may comprise of: tags the user appends to the user's friends, free text regarding other users, selection from a list of attributes provided by the system.

In various embodiments, the system attempts to minimize fraud. In the following examples, let user A and user B be registered users of the social network:

First, if user A provided information regarding user B, then that information can be checked for agreement with information provided by other users regarding B.
Second, in one embodiment the system may reward the user only when a user for which the first user provided other-regarding information clicks on an advertisement that appeared as response to that information.
Third, the system may decrease the reward for other-regarding information about another user (in our examples: user B) according to the amount of information the system already has regarding the other user (in our examples: user B).
Fourth, in one embodiment, the system may assign a decreased reward for clicks on adverts that repeated within a short period of time.

1. A method for increasing the accuracy of a profile of attributes, interests and preferences pertaining to individuals registered with virtual social networking services, wherein, in addition to self-regarding attributes, interests and preferences as divulged by the user during the registration process and web activity, registered users are encouraged to provide other-regarding attributes, interests and preferences pertaining to other registered users they claim familiarity with.

2. A method of doing business wherein virtual advertising purchasers are offered increased precision in targeting commercial audiences, provided by the proprietor of a virtual social networking service by means of the processing and cross referencing of self-regarding and other-regarding information pertaining to the attributes, interest and preferences of registered users with a virtual formation gathered by the proprietor of a virtual social network.

3. The method according to claim 1, additionally comprising a step of verifying said claim of familiarity.

4. The method according to claim 1, additionally comprising a step of rating the credibility of information provided by users.

5. The method according to claim 1, additionally comprising a step of cross-referencing and statistically matching other-regarding and self-regarding information.

6. The method according to claim 1, additionally comprising a step of encouraging the disclosure said other-regarding information by means of incentives, including: cash payment, micro-payments, virtual currency, virtual services, credit towards purchase of products, rebates, and virtual accreditation.

7. The method according to claim 6, wherein said users are awarded said incentives on the basis of actual clicks on adverts that were targeted at other users as a result of the information they provided.

8. The method according to claim 6, wherein said incentives are limited to adverts displayed on the web pages of the user that divulged said other-regarding information.

9. The method of doing business according to claim 2, wherein other-regarding information provided by individuals registered with a social networking service is rewarded by means of incentives, including: cash payment, micro-payments, virtual currency, virtual services, credit towards purchase of products, and virtual accreditation.

10. The method of doing business according to claim 9, wherein said incentives are financed directly by said advert purchasers.

11. The method of doing business according to claim 2, additionally comprising a step of gathering processing and selling the demographics of the users within said virtual social network that have been reported to show interest in the products advertised by said purchasers of adverts.

12. The method according to claim 1 additionally comprising a step of notifying registered users, who have indicated interest in making new romantic or social contacts, of the contact details of others who share their interests and activities.
